(19) United States
(12) Patent Application Publication
(10) Pub. No.: US 2010/0038208 A1
(43) Pub. Date: Feb. 18, 2010

(54) CONVEYOR DEVICE

(75) Inventors: CHIA-EN LEE, Shindian (TW); YONG YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/341,935

(22) Filed: Dec. 22, 2008

(30) Foreign Application Priority Data
Aug. 13, 2008 (CN) 200810303748.3

(51) Int. Cl. B65G 47/38

(52) U.S. Cl. 198/457.05

(57) ABSTRACT

A conveyor device is described. The conveyor device includes a conveyor belt and a receiver including a storing compartment and a guiding board. The guiding board is spaced above the conveyor belt, used to guide a part moving on the conveyor belt into the storing compartment without having to stop the conveyor device.

### BACKGROUND

1. Field of the Invention

The present invention relates to a conveyor device and, particularly, to a conveyor device used to convey components of electronic devices.

2. Description of Related Art

Electronic devices (e.g., mobile phones and computers) are usually assembled by using a conveyor device to convey its components to corresponding workstations for assembly.

A detecting device is usually positioned at the end of the conveyor device. When the conveyed component reaches the detecting device, the detecting device detects the component and then stops the conveyor device until the component is assembled. The assembled product is then removed from the conveyor device. However, such starting and stopping of the conveyor device degrades the efficiency of the conveyor device.

Therefore, there is room for improvement within the art.

### BRIEF DESCRIPTION OF THE DRAWINGS

Many aspects of the conveyor device can be better understood with reference to the drawings. The drawings are not necessarily drawn to scale, the emphasis instead being placed upon clearly illustrating the principles of the present conveyor device. Moreover, in the drawings like reference numerals designate corresponding sections throughout the several views.

FIG. 1 is an isometric view of a conveyor device, in accordance with an exemplary embodiment.

FIG. 2 is an isometric view of a conveyor device without the receiver shown in FIG. 1.

### DETAILED DESCRIPTION OF EXEMPLARY EMBODIMENT

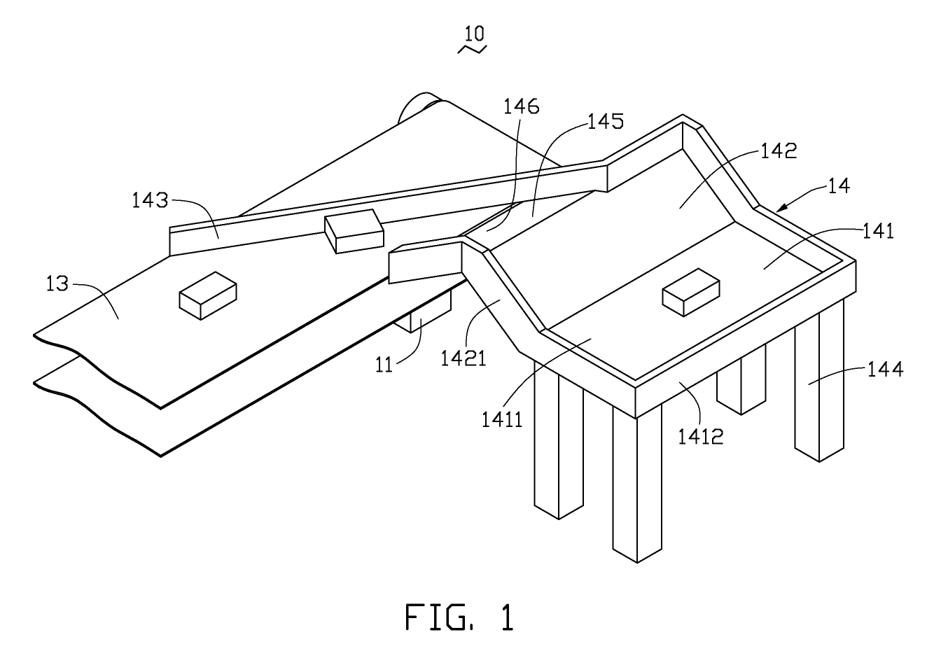

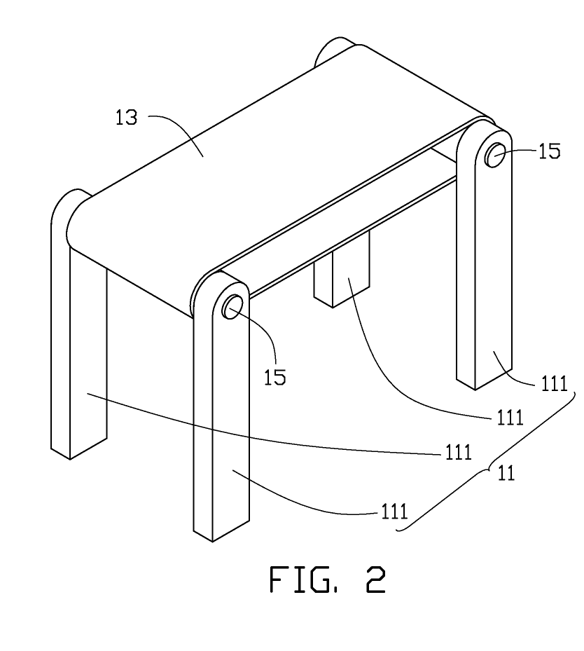

FIGS. 1 and 2 show an exemplary embodiment of conveyor device 10. The conveyor device 10 includes a frame 11, several rollers 15, a conveyor belt 13 and a receiver 14.

The frame 11 includes several supports 111. The frame 11 supports the rollers 15 and the conveyor belt 13.

The rollers 15 are rotatably mounted on the frame 11 and driven by a power source (not shown). The conveyor belt 113 is tightly wrapped around the rollers.

The receiver 14 includes a storing compartment 141, an inclined board 142, a guiding board 143 and a plurality, e.g., four supporting legs 144. The storing compartment 141 includes a bottom wall 1411 and a peripheral wall 1412 connected to a periphery of the bottom wall 1411.

One edge of the inclined board 142 connects to the bottom wall 1411 at an obtuse angle. Two side walls 1421 are formed along two other opposite sides of the inclined board 142 and connected to the peripheral wall 1412, respectively.

The guiding board 143 is a bent board spaced above a top surface of the conveyor belt 13 and connected to one side wall 1421. The guiding board 143 and the other side wall 1421 cooperatively define a gap 145, communicating with the storing compartment 141, between the conveyor belt 13 and the inclined board 142. One connecting board 146 can be filled in the gap 145 and connects a portion of the frame 11 to the inclined board 1427.

The four supporting legs 144 are fixed to the bottom wall 1411 to support the receiver 14.

In use, a component of the electronic device is conveyed on the conveyor belt 13 towards the gap 145. The component contacts the guiding board 143 and is directed by the guiding board 143 to the gap 145. Then, the component automatically slides along the inclined wall 142 into the storing compartment 141.

The guiding board 143 can guide the component to slide into the storing compartment 141. Thus, the storing compartment 141 can store the conveyed component for further assembly operations without having to stop the conveyor device 10, thereby increasing conveying efficiency of the conveyor device 10.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A conveyor device, comprising:
a frame;
a conveyor belt; and
a receiver including a storing compartment and a guiding board, the guiding board being spaced above the conveyor belt, and being used to guide a part moving on the conveyor belt into the storing compartment.

2. The conveyor device as claimed in claim 1, wherein the receiver further includes an inclined board, one end of the inclined board being connected to the frame, the other end being connected to the storing compartment at an obtuse angle.

3. The conveyor device as claimed in claim 2, wherein the inclined board is connected to the conveyor belt by a connecting board.

4. The conveyor device as claimed in claim 2, wherein the storing compartment includes a bottom wall and a peripheral wall, the peripheral wall being connected to the periphery of the bottom wall, the inclined board being connected to the bottom wall at an obtuse angle.

5. The conveyor device as claimed in claim 4, wherein two side walls are arranged on opposite sides of the inclined board, the side walls connected to the peripheral wall.
